(19) United States
(12) Patent Application Publication
(10) Pub. No.: US 2008/0147428 A1
(43) Pub. Date: Jun. 19, 2008

(54) METHOD AND ARRANGEMENT FOR PROVISIONING REMOTE SERVICE EQUIPMENT WITH POSTAGE FEE TABLES FROM A DATABANK

(76) Inventors: Gerrit Bleumer, Schildow (DE); Clemens Heinrich, Berlin (DE); Steffen Wittich, Berlin (DE)

Correspondence Address: SCHIFF HARDIN, LLP;PATENT DEPARTMENT, 6600 SEARS TOWER, CHICAGO, IL, 60606-6473, US

(21) Appl. No.: 11/957,816

(22) Filed: Dec. 17, 2007

(30) Foreign Application Priority Data
Dec. 18, 2006 (DE) 10 2006 060 700.7

(51) Int. Cl. G06Q 50/00; G06F 17/40

(52) U.S. Cl. 705/1

(57) ABSTRACT

In a method and arrangement for data processing to provision a service apparatus with postage fee tables, and for selection of the tables from a databank of a data center that accepts a communication connection to the service apparatus after the service apparatus calls in, the databank is automatically provisioned with a number of updated and corrected postage fee tables and automatically selects postage tables from the databank in a data center.

### BACKGROUND OF THE INVENTION

1. Field of the Invention

The present invention concerns a method and arrangement for data processing in order to provision remote service equipment with postage fee tables from a databank, in particular a databank at a data center in communication with the service equipment.

2. Description of the Prior Art

Postage fee tables are required for calculation of the postage value in service apparatuses (in particular in a franking machine), postage-calculating scales or in a mail processing system. Postage fee tables provide data structures that link various items of information for the price (cost) or postage calculation of a shipping process. Postage fee tables include associations between franking products such as letter products (extra-large letter, normal letter, etc.), shipping types (registered mail) and their prices. The fees for additional letter services and deductions of specific agreement categories (for example between customer and postal authority) are provided for the calculation, as well as zone tables that map geographical postage regions and their respective prices. At least one postage fee table is loaded into a service apparatus during a communication connection (communication session) with the data center.

Either a franking machine with a passive (non-calculating) scale or a postage-calculating scale is used in order to calculate the postage amount for the shipping of a mail piece. A mail processing system with a dynamic scale and a franking machine is known, which communicates with a data center.

According to U.S. Pat. No. 4,122,532 (=DE 28 03 982 C2), a new tariff (rate) table is simultaneously remotely transferred from a central data station to a number of franking machines, but updating with the new tariff requires that the franking machines are activated at these points in time and can be maintained in communication with the data center for the time duration necessary for the updating.

A service apparatus known from U.S. Pat. No. 4,138,735 (=DE 28 03 919 C2) has a rate PROM that can be provided with a current postage fee table via radio or telephone. An asynchronous transfer of a postage fee table to all service apparatuses results by an individual addressing of each service apparatus. The current postage fee table includes an incrementable modification number for the revision data segment. It is verified by the microprocessor of the service apparatus that a data block transmitted by a transmission station contains the correspondingly incremented modification number of the revision data segment. Although a series of tables is secured by such a modification number, the incrementing of the modification number occurs in the service apparatus, i.e. in the franking machine itself. The method is time-consuming and fails if the attempted connection acceptance by the data center is unsuccessful.

Advance planning for the early compilation of postage fee tables for a future tariff change of postage fee values, such that these are made widely accessible before they come into effect for all mail customers, is known from EP 911767 B1. This procedure depends on providing the majority of the participants with a current postage fee table in a timely manner instead of simultaneously, as before. Future postage fee tables that are effective as of a future update dates are therefore stored in memory regions for further postal authorities, advantageously for each of multiple national postal authorities. Given a requirement of the user for postage fee tables, an “on demand downloading” is initialized by the service apparatus, for example by a franking machine. For each of the tables, the date that is to be included in the date stamp appearing on the mail item is to be compared by the control unit of the service apparatus with the update (effective) date for the particular table.

An automatic transfer system with a number of slots for chip cards is known from U.S. Pat. No. 4,802,218. This known service apparatus is too large and too expensive of practical use. In addition to a chip card for a postage fee table with which the aforementioned postage fee value is determined (but without a prior downloading), a further chip card is also simultaneously used for the credit downloading and billing.

A method for data input into a service apparatus and an arrangement for implementation of the method is known from EP 986028 A2. A first-time loading of a valid postage fee table ensues given an initialization of the service apparatus. The downloading of a valid table is necessary when an invalid table is present. Before a further postage fee table is loaded, a status message is transmitted from the service apparatus to the data center. The version number and revision number are thereby respectively of importance for differentiation among the postage fee tables. There is no disclosure, however, as to how and where the required organization is established if multiple postage fee tables are to be administered. Although delivery of a new postage fee table can ensue by loading via a modem, the internet or a chip card, this leads to a time delay in the franking with a new tariff table if the loading and updating of the new tariff and a franking follow in immediate chronological succession.

Loading before the effective data of new tariff table data of one postal carrier is proposed in EP 991025 B1, the loading automatically ensuing at a user-defined first point in time and the actual updating automatically ensuing in the service apparatus at a carrier-defined second point in time.

Delivery and storage of a first currently valid postage fee table and a second postage fee table that will be valid in the future is known from CA 2264622 C (=WO 98/57305, =EP 920679 A4). A fee calculation ensues either with the aid of a second postage fee table that will be valid in the future in order to allow pre-franking of mail items that are franked before the effective date but will enter the mailstream after the effective date, or with the aid of a first, currently valid postage fee table for the franking of current mail. It is disadvantageous that the transfer of the currently valid postage tariff table as well as the next postage tariff table cannot ensue automatically without further inputs into a service apparatus.

A data center that has at least one databank, one control unit and a communication unit for data exchange with external franking systems is known from German patent application DE 10 2004 014 427 A1 with the title “Method for a server-controlled security management of renderable services and arrangement for provision of data according to a security management for a franking system”.

### SUMMARY OF THE INVENTION

An object of the present invention is to provide a method for data processing with provision of postage fee tables in a databank and for automatic selection of postage tables from the databank of a data center, as well as an arrangement for implementation of such a method, wherein at every point in time, transfer of the currently valid and next postage fee tables from the data center to the service apparatus should be enabled dependent on the set of postage fee tables that is already present in the service apparatus.

The object is achieved in accordance with the invention by a method for data processing with automatic provision of a number of updating and corrected postage fee tables in a databank and with an automatic selection of postage fee tables from the databank of a data center dependent on the versions of postage fees present in the service apparatus. When the service apparatus accepts a communication connection to the data center, the automatic selection and timely transmission of tables for the purpose of updating a number of tables in the service apparatus is automatically enabled. The method ensures the correct selection from among a number of postage fee tables that are stored in the data center and operates with central controlled downloading using machine parameters of the service apparatuses (machine type, model, variant, version/revision of the hardware or operating software, etc.) or individually for individual machines, as well as using a respective postage table set communicated by the service apparatus (which postage table set is, for example, communicated during the downloading process of a monetary credit). The service provided by the data center for provision of a number of updated postage fee tables that are available in the databank is thereby improved.

Moreover, a subsequent reorganization of the postage fee tables in the data center is possible, for example in the event of errors in the data set, such that the forthcoming dial-in (establishment of the communication set-up) of the service apparatus effects an updating of the table set. An automatic revising of the postage fee table set in the server of a data center guarantees a running (continuous) timeliness of the data set of postage fee tables in the databank of the server during the downloading of the service apparatus.

The automatic provision of at least one updated and (with regard to its version data) corrected postage fee table in a databank ensues as a result of an input of a new postage fee table in a module for version data processing, with subsequent data processing of the at least one input new postage fee table of a postal carrier, in the data center. The input postage fee table is convenient into machine-readable form, and with the new postage fee table is stored in a databank of the data center. A query is made as to whether only one postage fee table is stored in the databank of the data center, and a version number is associated therewith when only one postage fee table is stored. The storage of the version number ensues at the postage fee table before release of the newly input postage fee table for downloading into a remote service apparatus when, in response to the query, it is determined that no further postage fee table of the further postage fee tables stored in the databank is to be considered; or if further queries are implemented when, as a result of the first query, further postage fee tables stored in the databank are still to be considered. A predetermined allocation scheme for the version number of the postage fee tables exists with regard to each query.

Furthermore, the version data include a number composed of a main section number and subsection number. This number, uniquely associated with a postage fee table, is stored in the databank of the data center, whereby a main section number according to a first allocation scheme is formed with regard to a new postage fee table by the previous maximum main section number being incremented by “one” when the following criteria are fulfilled: further postage fee tables stored in the databank are still to be considered and a postage fee table with a maximum effective date for the beginning of validity exists which is established in a first query step, and the maximum date of the beginning of validity of the new postage fee table is greater than or equal to the maximum date of the beginning of validity which is established in a second query step.

In a further embodiment, the main section number and the subsection number are associated with a new postage fee table according to a second allocation scheme; whereby the main section number associated with the new postage fee table is equal to the previous maximum main section number; and whereby the subsection number is set to the value “one” when the following criteria are fulfilled: (a) further postage fee tables stored in the databank are still to be considered, which is established in a first query step, and a postage fee table with a minimal date of the beginning of validity exists, and (b) the date of the beginning of validity of the new postage fee table is greater than or equal to the minimum date of the beginning of validity which is established in a third query step, and (c) a next postage fee table is continuingly selected beginning from that postage fee table with a maximum date of the beginning of validity, by means of which continuing selection it is checked whether the date of the beginning of validity of the new postage fee table is greater than or equal to the date of the beginning of validity of the selected postage fee table, which is established in the fourth query step of a subroutine.

In a further embodiment, change of the subsection number is effected corresponding to the second allocation scheme for the version numbers of the remaining postage fee tables and in the databank a selection of a next table ensues in sequence according to its date of beginning of validity, and the index of the next table and the subsection number are incremented by “one”.

In a further embodiment, after the change of the version number of the at least one new postage fee table which is present in the databank, storage of the version number ensues associated with the postage fee tables and their release dates, the data processing is completed.

A server of the data center includes a first module for version data processing and a second module for automatic postage table selection. The version data processing by the first module enables an automatic provisioning of a number of postage fee tables in the databank that are updated and corrected with regard to their version data.

The server of the data center is programmed to revise the at least one postage fee table of the service apparatus and first controls the dynamic correction in the data center. When the service apparatus requires a corrected postage table (such as, for example, given errors), a correction is achieved by erasing data and loading tables that are subsequently provided with a new version number. Upon each generation of a further postage fee table in the databank it is checked whether further postage fee tables must be renamed.

The service of the server to provide a number of updated postage fee tables in the databank is thus improved. The postage fee table selection ensues dependent on the version number or its progression and beginning of validity. In addition to the aforementioned criteria, the selection of the postage fee table can take into account an optional validity transmission in order to prevent its delivery at a point in time that is too late (i.e. after the end of the validity of a postage fee table) given a download request. An exchange of incorrect postage tables would then be possible. The correction process in the data center subsequently ensures the updating of the version numbers of postage fee tables in the databank of the server.

In addition to an automated provisioning of data by the data center, the selection is implemented in a customer-specific manner by the server of the data center.

The server of the data center is programmed for case differentiation according to the machine state of the service apparatus and controls the downloading of at least one postage fee table in a service apparatus according to predetermined conditions:
If, for example, the service apparatus contains no postage fee table (first state), the data center then transfers that table with the valid version number into the service apparatus.
When the service apparatus contains only one valid postage fee table (second state), the data center then transfers that table with the next highest version number. It should not thereby be precluded that, if applicable, a future valid table with a corresponding, subsequently higher version number is likewise transferred.
A third state arises when the service apparatus contains no valid postage fee table. The data center then transfers the valid postage fee table with the correspondingly associated version number.
A further, fourth state arises when a future valid postage fee table is already present in the service apparatus, meaning that no table is required and therefore no table is loaded as well.

Either a design of the control unit of the data center as a postage table specification server ensues or the design of the entire data center as a server can be effected. A transmission of postage tables into a service apparatus from a data center is possible by means of a modem or another typical device for remote data transfer.

### BRIEF DESCRIPTION OF THE DRAWINGS

FIG. 1 is a block diagram of a system with a server and a service apparatus in accordance with the invention.

FIG. 2 is a block diagram of a system with a data center and a service apparatus in accordance with the invention.

FIG. 3 is a flowchart of an embodiment the method for automatic provisioning of postage fee tables with version data in accordance with the invention.

FIG. 4 is a flowchart of the method for automatic selection of a postage fee table in accordance with the invention.

FIG. 5a describes table selection in a normal case in accordance with the invention.

FIG. 5b describes table selection in an error case in accordance with the invention.

FIG. 6 is subroutine with an allocation scheme for version numbers of corrected postage fee tables in accordance with the invention.

### DESCRIPTION OF THE PREFERRED EMBODIMENTS

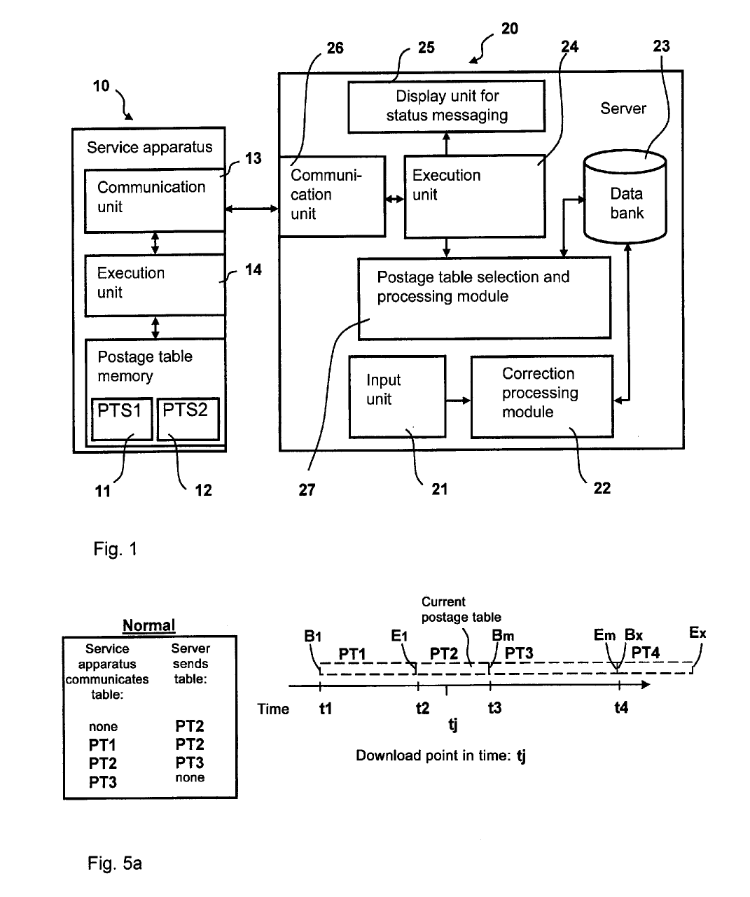

FIG. 1 shows a block diagram of a system with a server 20 and a service apparatus 10. An entire data center is realized as a server. The server 20 has an input unit 21 that is operationally connected with a databank 23 via a first module 22 for version data processing, whereby the databank 23 is operationally connected with an execution unit 24 via a second module 27 for automatic postage table selection. The execution unit 24 is operationally connected with a display unit 25 for status messaging and with a communication unit 26. The execution unit 24 has access to the databank 23 of the data center via the second module 27 for automatic postage table selection. The service apparatus 10 has a read-only memory 11 for storage of the operating software, a non-volatile memory 12 for storage of the automatically selected and transmitted postage fee tables, a communication unit 13 and an execution unit 14. The operating software is a program package that constitutes or determines the function of the service apparatus. For example, it contains the program functionality of the offered services and commands for their execution. The operating software accesses the postage table of the products and price for calculation of the postage value for a indicia procedure.

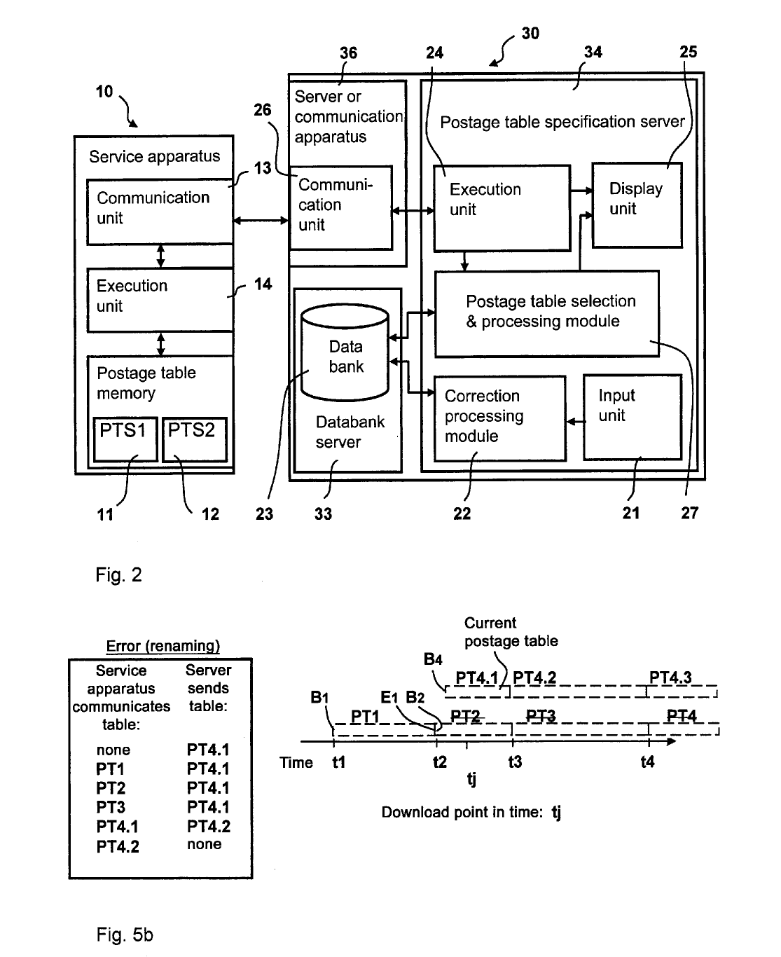

FIG. 2 shows a block diagram of a system with a data center and a service apparatus. The data center 30 represents the vendor or supplier for remote services for at least one service apparatus 10. The service apparatus 10 is designed as was already explained using the exemplary embodiment according to FIG. 1.

For the communication with such service apparatuses (such as franking machines or indicia apparatuses), the data center operates such devices (such as, for example, computer systems) that possess network connections or modem banks, terminal servers, databanks etc. For example, a data center 30 with distributed tasks has a communication server 36 and a databank server 33 which are both operationally connected with a postage fee table specification server 39. The communication server 36 has a communication unit 26 and the databank server 33 has a databank 23. The postage fee table specification server 39 has an input unit 21 that is operationally connected with a first module 22 for version data processing. The postage fee table specification server 39 furthermore has a second module 27 for automatic postage table selection that enables an access to the databank 23 and accesses the databank of the data center for automatic selection of postage fee tables. The second module 27 for automatic postage table selection is operationally connected with an execution unit 24 and a display unit 25.

The procedure in the data center is explained using FIG. 2. The parameters of the new or corrected postage fee table are provided by the input unit 21 to the first module 22 for version data processing, i.e., for correction processing. The first module 22 accesses the set of postage fee tables in the databank and reorganizes the set by assignment of altered version information.

After input and processing of the postage fee tables delivered by the postal carrier (carrier), storage thereof in the databank ensues. The processing includes correction processing of the table and the automatic generation and association of new version numbers. The generation and association of new version numbers of postage fee tables ensues in the databank of a server. Two versions are proposed for the method, that are independent of how an automatic change of the version is actually implemented:
1. The automatic generation and association of new version numbers first ensues in a telephone call of the service apparatus that allows the data center to distinguish this service apparatus from other apparatuses. The correction procedure of the version number advantageously ensues during the call-up of the service apparatus to the data center.
2. The automatic generation and association of new version numbers already ensues before calling by the service apparatus to the data center, and non-specifically for the service apparatus relative to other service apparatuses. The correction procedure of the version numbers advantageously ensues as a result of an input 101 of postage fee tables in a first module 22.

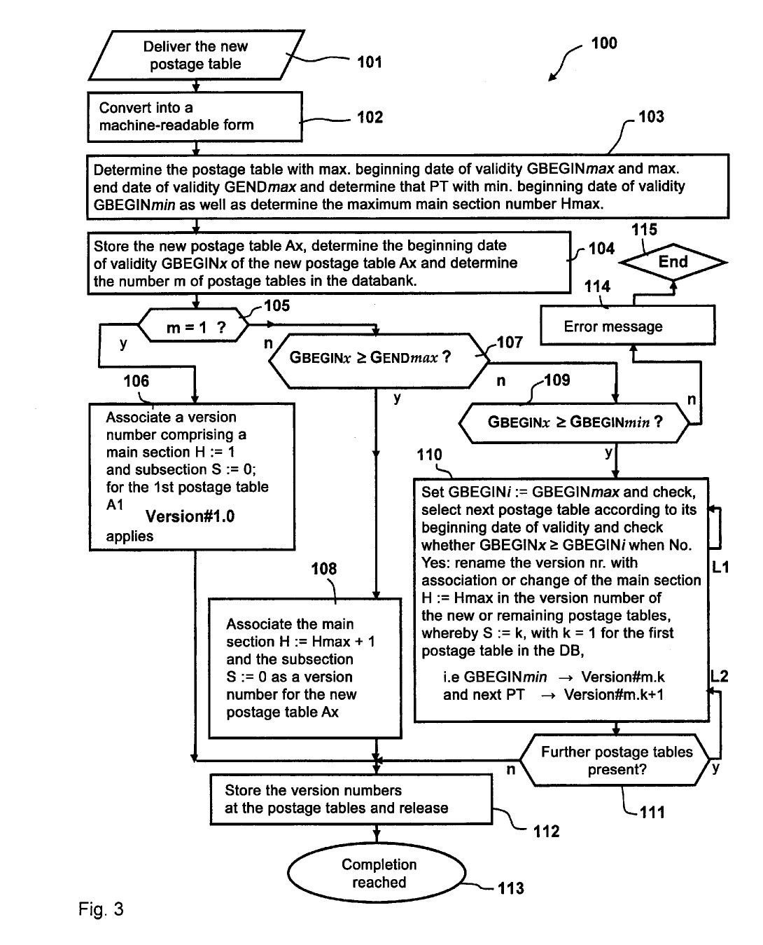

The method for provision of a number of updated and corrected postage fee tables in a databank includes an automatic correction of postage fee tables in the databank. The automatic correction method allows the maintenance of the data set in the data center after changes in postage tables already provided for service apparatuses have been necessary, and is subsequently explained in further detail using FIG. 3.

FIG. 3 shows a flowchart of the method for automatic provisioning of postage fee tables with version data. A respective, additionally stored version number is used for provision of a number of updated and corrected postage fee tables in a databank. The method for automatic provisioning 100 of a number of postage fee tables that are updated and (with regard to their version data) corrected in a databank is implemented by means of the first module 22 for version data processing as a result of an input 101. The method includes a data processing of each of the input postage fee tables of a postal carrier in the data center with conversion 102 of each of the input postage fee tables in a machine-readable form and a storage 104 in a databank 23 of the data center. After a first query step 105, an association of a first version number 106 and storage 112 and release of a newly input first postage fee table for downloading into a remote service apparatus 10 ensues when only a single postage fee table is stored in the databank 23, i.e., no further postage fee tables are to be taken into account.

Otherwise, when further postage fee tables are stored in the databank 23, to determine postage table parameters in a third step 103 said databank 23 detects those postage fee tables which have already been stored previously. The aforementioned third step 103 is placed between the second step 102 for conversion and the fourth step 104 for storage.

A first postage table parameter is the maximum beginning date of validity GBEGINmax which specifies the date of the entry into force of that postage table which lies furthest in the future.

A second postage table parameter is the maximum end date of validity GENDmax which specifies the date of the invalidation of that postage table which lies furthest in the future.

A third postage table parameter is the minimal beginning date of validity GBEGINmin which specifies the date of the entry into force which lies furthest in the past.

When, corresponding to the query in the first query step 105, further postage fee tables A₁ . . . Aᵢ . . . Aₙ stored in the databank 23 are to be taken into account (whereby their number m is naturally not equal to one), a selection ensues in a second query step 107 which enables a version number to be allocated that differs from the others only in the main section of the version number. That is the case when the criterion is satisfied that a maximum end date of validity GENDmax of the previous postage fee table Ai follows after the beginning date of validity GBEGINx of the new postage fee table Ax.

After an association of a version number in a subsequent step 108, its storage and release of the new postage fee table ensues in a step 112 for the purpose of downloading the new postage fee table from the databank 23 into a remote service apparatus 10.

In the case of correction, the table version number is changed, whereby the aforementioned criterion (that a maximum end date of validity GENDmax of the previous postage fee table Ai follows after the beginning date of validity GBEGINx of the new postage fee table Ax, i.e. given x=i+1) now no longer applies.

However, the criterion should now apply that a minimal beginning date of validity GBEGINmin of a first postage fee table A₁ should follow or is the same as the beginning date of validity GBEGINx of the new postage fee table Ax, i.e. given x≧1.

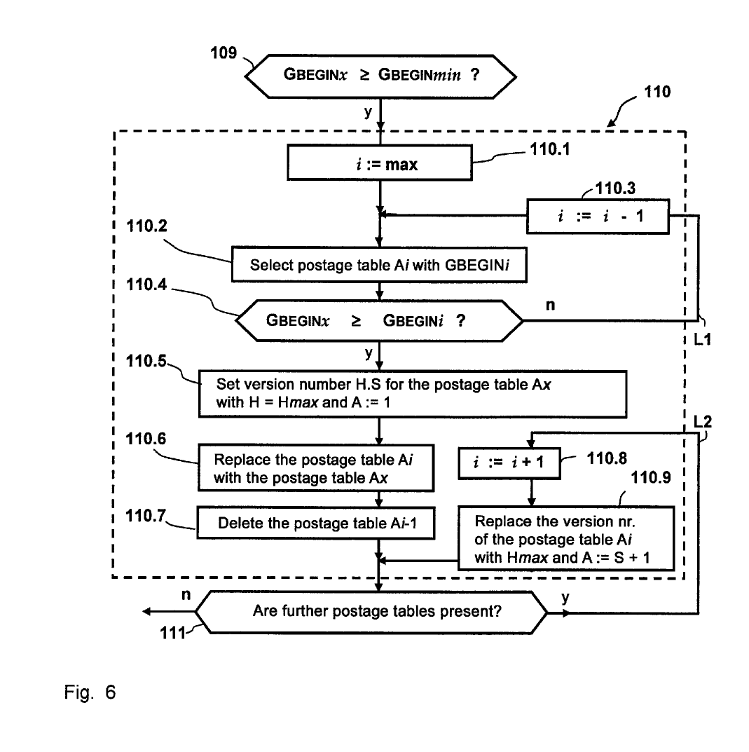

The aforementioned condition is queried in a third query step 109 that follows the second query step 107. The process then branches to a subroutine 110 in order to individually call and rename the postage fee tables to be renamed. The subroutine 110 is explained in further detail further below using FIG. 6.

A selection of a next table Aᵢ₋₁ from the databank in order according to its beginning date of validity is enabled, whereby the selection starts from the maximum beginning date of validity GBEGINmax of that postage fee table Ai (with i=max) which lies farthest in the future. When the beginning date of validity GBEGINᵢ of the postage fee table Aᵢ to be used for comparison is neither smaller than nor equal to the beginning date of validity GBEGINₓ of the new postage fee table, a loop L1 is run through and the next postage table Aᵢ₋₁ is selected according to its beginning date of validity. For this purpose the index number i is decremented by “one” in a first loop L1. However, when the comparison criterion GBEGINₓ≧GBEGINᵢ is satisfied, a renaming of the version number of the new or remaining postage fee tables ensues, which postage fee tables receive as a main section number H the previous maximum value and as a subsection number a “one” or a number incremented by “one”. For incrementing a second loop L2 is run through when further postage fee tables are present in the databank, which is queried in a query step 111; the process then branches back to the subroutine 110. For selection of a next postage fee table the order of the postage fee tables is again determined according to the beginning date of validity, and this time the index i is incremented.

After the change of the version number of the at least one new postage fee table during the run duration of the subroutine 110 and the query in the query step 111, a storage and release (in step 112) of the at least one new postage fee table corrected with regard to its version data ensues and the completion of the data processing is achieved in a step 113.

The correction of the postage table set is an independent process with regard to the call-in of the service apparatus and the download protocol. The set of the postage tables is databank is modified, primarily with regard to their version information.

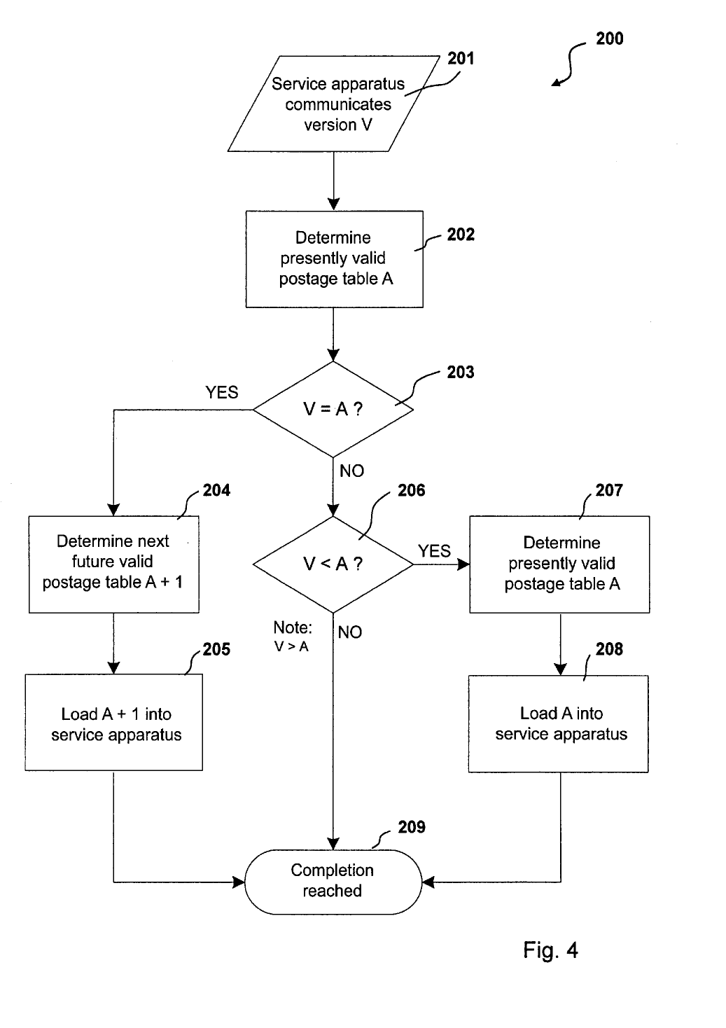

For downloading of postage fee tables the service apparatus establishes a connection to the data center, for example by means of a modem, an ISDN card or a network card. The communication is coupled to a connection protocol of the two parties. The service apparatus communicates its, state in the course of the download protocol in that it transfers the highest version number of the held postage tables to the data center. In the data center the transferred highest version number of the service apparatus is transferred from the communication unit 26 via the execution unit 24 into the postage table selection and processing module 27. In the automatic postage fee table selection, the postage fee table selection and processing module 27 compares the displayed version number of the service apparatus with the set of the postage tables in the databank and, using the method in the flow plan for automatic selection of the postage fee table (FIG. 4), determines whether and (in the event of yes) which postage fee table is transferred to the service apparatus for updating. The automatic selection method is independent of whether the set of postage fee tables corresponds to the original version/revision or was corrected via later access. The following cases can thereby occur:

a) The Service Apparatus Contains No Postage Fee Table

When the service apparatus contains no postage fee table at the point in time of the download, the table valid at the point in time of the download is loaded from the set of the data center.

b) The Service Apparatus Contains a Postage Fee Table
b1) The service apparatus already contains an invalid postage fee table at the point in time of the download; a table valid at the point of time of the download is thus loaded.
b2) The service apparatus already contains a valid postage fee table at the point in time of the download; a next table valid in the future is thus transferred.
   c) The Service Apparatus Requires No Updated Postage Fee Table

In the loading procedure the service apparatus communicates the version number of the next table valid in the future; no postage fee table is thus transferred.

d) The Service Apparatus Requires a Corrected Postage Fee Table

A correction or insertion into the set of the postage tables in the data center is necessary; the process proceeds according to the following:
d1) The set is revised via deletion of incorrect tables or, respectively, insertion of new tables and is subsequently provided with new version numbers (see below).
d2) The download is continued with the method described above.

The selection of the postage tables is a procedure that is executed when a service apparatus calls in. The service of the server exists in the provision of a number of updated postage fee tables in the databank.

FIG. 4 shows a flowchart of the method for automatic selection of a postage fee table. The automatic selection 200 of postage fee tables from the databank of a data center ensues dependent on the versions of postage fees present in the service apparatus, comprising: a communication 201 of the version data V of a postage fee table stored in the service apparatus (which communication ensues in the transmission of the versions of postage fees presented in the service apparatus to the data center); a determination 202 of the current valid postage fee table; and a checking 203 of its version data A for agreement with the communicated version data V of the service apparatus 10 in a second module 27 of the data center. The automatic selection 200 of postage fee tables from the databank of a data center comprises a determination 204 of the next version A+1 of a future valid postage fee table before its loading 205 into the service apparatus 10 when, in the second module 27 of the data center, an agreement of the version data A of the currently valid postage fee table with the communicated version data V of a current postage fee table of the service apparatus 10 is established.

The automatic selection 200 of postage fee tables from the databank of a data center comprises a determination 204 of the version A of a valid postage fee table, that is current at the time before its loading 208 into the service apparatus 10 when, in the second module 27 of the data center, a disagreement of the version data A of the currently valid postage fee table with the communicated version data V of a current postage fee table of the service apparatus 10 is established, and when the currently valid postage fee table has the higher rank.

The currently valid postage fee table has the higher rank when the version data A are higher than the version data V of the current postage fee table of the service apparatus 10. For example, it is provided that the version data A can be greater with regard to their alphanumeric value than the alphanumeric value of the version data V. A correction procedure that was effected beforehand or during the call-in thereby ensures the updating of the data set of postage fee tables in the databank of the server.

The correction processing is an automatic administration or, respectively, maintenance process of the data set. Both procedures are coupled insofar as the correction processing must satisfy a requirement of the renaming/saving that is compliant with the later selection of a naming convention, version/revision or storage in the databank.

The table selection in the normal case is presented as an exemplary embodiment in FIG. 5a. The validity of a first postage fee table begins in B1 at a first point in time t1 and ends at E1 at a point in time t2. The service apparatus receives the first postage fee table PT1 and associated version information 1.0 early, at the latest upon the initialization of the service apparatus. A second postage fee table PT2 and associated version information 2.0 will be valid at a second point in time t2. Further postage fee tables with a higher version number that only enter into force in the future can be stored in a databank of the data center. Normally, the beginning Bi of the next postage fee table Ai lies at the end Ei−1 of the preceding postage fee table Ai−1. For example, in FIG. 5a the preceding postage fee table Ai−1 is the third postage fee table PT3 and there exists no postage fee table whose beginning date of validity Bm would be greater, i.e. Bm is maximal at the point in time t3. This likewise applies for the end date of validity Em. The beginning date of validity Bx of a new postage fee table BT4 begins at the point in time t4 when the end date of validity Em of the previous maximum valid postage fee table PT3 coincides with the beginning date of validity Bx of the new postage fee table PT4. At the point in time tj of download, the currently valid postage table is the second postage fee table PT2 in the version 2.0.

Even in an exception case (not shown) in which the postage fee tables in the databank have not been chained together without temporal gaps, and in which the download point in time tj falls precisely in the gaps, a currently valid postage table is transmitted, namely the previously valid postage table without consideration of its end date of validity.

In the shown normal case, at the point in time tj the service apparatus possesses a communication connection with the data center. The postage fee table PT1 and associated version information 1.0 stored in the service apparatus and valid as of the first point in time t1 can be overwritten because the previously valid postage fee table is already invalid at the point in time tj of the download and a currently valid postage fee table exists in the databank and can be loaded at the point in time tj of the download. The version associated with the currently valid second postage fee table PT2 reads 2.0.

In another case the service apparatus already contains a currently valid postage fee table at the point in time of the download; a next table PT3 of the version 3.0 that will be valid in the future as of a third point in time t3 is thus transferred. A fourth postage fee table PT4 and associated version information 4.0 that are valid as of a fourth point in time t4 can in fact already be stored in the databank, however are not yet transferred to the service apparatus. Before the storage of the fourth postage fee table PT3, the valid third postage fee table PT3 is the maximum version and has a maximum beginning date of validity GBEGINmax as well as a maximum end date of validity GENDmax. The first postage fee table PT1 has a minimal beginning date of validity GBEGINmin. These aforementioned three postage table parameters are used to generate the version information. That is particularly advantageous when postage fee tables must be retroactively corrected after taking effect at their beginning date of validity or when the postage fee tables mutually chronologically intersect, whereby the corrected postage fee table begins before the end date of validity of the previously valid postage fee table has been reached.

The table selection in the error case is presented as an exemplary embodiment in FIG. 5b. The error case is indicated by a crossed-out (old) version number. For example, an allocation scheme as described using FIGS. 3 and 6 exists for a renaming. The crossed-out (old) version number drawn in FIG. 5b is thereby replaced with a corrected version number. The version number associated with the second postage fee table PT2 to be replaced was originally 2.0. At the beginning B2 of its validity the error was not yet known. At the beginning B4 of the validity of the corrected postage fee table, i.e. in the time range between the point in time t2 and the downloading at the point in time tj, a correction of the previous second postage fee table PT2 has occurred in the data center. Its corrected version has the version 4.1 and thus begins to be valid at a later point in time than at the end of the validity of the first postage fee table PT1, which makes the version number change necessary in order to differentiate this from the second postage fee table PT2 of the version 2.0 that was valid in the interim. This version number change also extends to further postage fee tables that only become valid at a later point in time, meaning that the previous third postage fee table PT3 of the version 3.0 receives the version 4.2 in the data center and the previous fourth postage fee table PT4 of the version 4.0 receives the version 4.3 in the data center.

A subroutine 110 with an allocation scheme for version numbers of corrected postage fee tables is shown in FIG. 6. The subroutine 110 is reached starting from the selection step 109 for correction of the version number of postage fee tables. In a first step 110.1, an index i is set to the maximum value corresponding to the number of postage fee tables stored in the databank and in a second step 110.2 the corresponding postage fee table is selected that corresponds to the maximum index i and has a beginning date of validity GBEGINi.

In the subsequent fourth query step 110.4, the criterion of whether the beginning date of validity of a new postage fee table delivered for storage in the databank is greater than or equal to the beginning date of validity of the selected postage fee table is queried, i.e. whether GBEGINx≧GBEGINi. If that is not the case, in a third step 110.3 the index i is decremented by “one” and, via the third step 110.3, the process branches back to the beginning of the second step 110.2 over a first loop L1.

Otherwise, the criterion is satisfied and a fifth step 110.5 is reached in which the version number H.S is set for the new postage fee table Ax, whereby its main section H:=Hmax and subsection S.=1.

In a subsequent sixth step 110.6, the postage fee table Ai selected via the decrementing in the first loop L1 is replaced by the more current version of the new postage fee table Ax.

In a subsequent seventh step 110.7 a preceding valid postage fee table Ai−1 is erased from the databank when the latter is no longer currently valid.

The query step 111 is then reached and it is queried whether further postage fee tables are present in the databank.

If that is not the case, the process branches to the twelfth step 112 in the workflow according to FIG. 3 in order to store the updated version numbers regarding the postage fee tables in the databank.

Otherwise, if that is the case the index i is incremented by the value “one” in an eighth step 110.8 and, via a ninth step 110.9, the process branches back to the beginning of the query step 111 over a second loop L2. In a ninth step 110.9 the version number of the selected postage fee table Ai is replaced by the previous maximum main section number Kmax and the previous subsection number is replaced by a subsection number S:=S+1 incremented by “one”.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for provisioning postage fee tables from a data center to a service apparatus remote from the data center, comprising the steps of:
storing a plurality of postage fee tables in a databank at a data center;
at the data center, automatically updating and correcting the stored postage fee tables in the databank as needed;
at said data center, accepting a communication connection from a service apparatus remote from the data center; and
at the data center, upon accepting said communication connection, automatically selecting at least one postage fee table from said data bank for transmission to the service apparatus.

2. A method according to claim 1 comprising:
automatically provisioning at least one updated and, with regard to version data, corrected postage fee table in the databank as a result of an input of a new postage fee table in a first module for version data processing;
processing the at least one input new postage fee table in the data center with conversion of the input postage fee table into a machine-readable form;
storing the new postage fee table in the databank of the data center;
querying whether only one postage fee table is stored in the databank and associating a first version number if only one postage fee table is stored in the databank;
storing the version number at the postage fee table and releasing the newly input postage fee table for downloading into the remote service apparatus if corresponding to the first query, no further postage fee table among further postage fee tables stored in the databank is to be taken into account; and
making queries further if, as a result of the first query, further postage fee tables stored in the databank are to be taken into account, with an allocation scheme for the version numbers of the postage fee tables existing for each query.

3. A method according to claim 2, comprising:
automatically selecting a postage fee table from the databank of a data center dependent on versions of postal fees that are present in a service apparatus, by communicating version data of a postage fee table stored in a service apparatus in the communication connection by the service apparatus to the data center;
at the data center, determining a currently valid postage fee table and a checking version data thereof for agreement with the communicated version data of the service apparatus;
in a second module of the data center, using an order for selection of a next table according to a validity date of the postage fee table.

4. A method according to claim 3, comprising automatically selecting postage fee tables from the databank of the data center by determining a next version of a future valid postage fee table before loading thereof into the service apparatus if in the second module of the data center, agreement of the version data of the currently valid postage fee table with the communicated version data of a current postage fee table of the service apparatus is established.

5. A method according to claim 2, comprising making a call-in from the service apparatus into the data center before the automatic selection, and in that a correction procedure is effected in the data center during the selection, that ensures updating of the data set of postage fee tables in the databank of the data center.

6. A method according to claim 2, comprising automatically generating and associating the new version numbers before a call-in by said service apparatus to the data center, by inputting the postage fee table into the first module.

7. A method according to claim 6, comprising conducting the version data processing identically for all service apparatuses.

8. A method according to claim 6, comprising the currently valid postage fee in higher rank when the version data thereof are higher than the version data of the current postage fee table of the service apparatus.

9. A method according to claim 8 determining, the rank of version data with regard to an alphanumerical value thereof.

10. A method according to claim 2 comprising automatically selecting postage fee tables from the databank of the data center by determining a single valid postage fee table in a time of a current version before loading thereof into the service apparatus if in a second module of the data center, disagreement of the version data of the currently valid postage fee table with the communicated version data of a current postage fee table of the service apparatus is established when the currently valid postage fee table has the higher rank.

11. A method according to claim 1, comprising forming the version data to comprise a number consisting of a main section number H and subsection number S that, respectively associated with a postage fee table, is stored in the databank of the data center and, for a new postage fee table, forming the main section number H according to an allocation scheme comprising incrementing previous maximum second number Hmax by a value “one” when the following criteria are fulfilled: that further postage fee tables stored in the databank are still to be taken into account, whereby a postage fee table with a maximum beginning date of validity exists, which is established in a first query step, and that the beginning date of validity f the new postage fee table is greater than or equal to the maximum beginning date of validity which is established in a second query step.

12. A method according to claim 1, comprising forming the version data to comprise a number consisting of a main section number H and subsection number S that, respectively associated with a postage fee table, is stored in the databank of the data center, and associating a main section number H and subsection number S with a new postage fee table according to an allocation scheme comprising associating the main section number H setting the new postage fee table that is equal to a previous maximum second number Hmax and setting the subsection number to a value “one” when the following criteria are fulfilled: first, that further postage fee tables stored in the databank are still to be taken into account, which is established in a first query step, whereby a postage fee table with a minimum beginning date of validity exists, and second, that the beginning date of validity of the new postage fee table is greater than or equal to the minimum beginning date of validity, which is established in a third query step; and third, that, beginning from that postage fee table with a maximum beginning date of validity, a next postage fee table is progressively selected and checking whether the beginning date of validity of the new postage fee table is greater than or equal to the beginning date of validity of the selected postage fee table, which is established in a fourth query step.

13. A method according to claim 12, comprising changing the subsection number in the allocation scheme for the version numbers of the remaining postage fee tables by, in the databank, making a selection in order of a next table according to the date of the beginning of its validity, whereby an index of the next table and the subsection number are incremented by the value “one”.

14. A method according to the claim 12 comprising, after changing the version number of the at least one new postage fee table which is present in the databank, storing the version number with regard to the postage fee tables and releasing of the postage fee table, corrected with regard to its version data.

15. An arrangement for provisioning a service apparatus, remote from a data center, with postage fee tables, comprising:
a communication unit at the data center that accepts a communication connection from the service apparatus after a call-in to the data center by the service apparatus;
a server and a databank in communication with the communication unit at the data center, said databank having postage fee tables stored therein;
said server comprising a first module for version data processing of the respective postage fee tables and a second module for automatic postage fee table selection from the databank; and
said first and second modules, upon acceptance of said communication connection, automatically selecting at least one postage fee table from the databank and automatically making the selected at least one postage fee table available for transmittal to the server apparatus.

16. An arrangement according to claim 15, wherein the data center is formed as a server, the server forming the data center comprising an input unit that in communication with the databank via the first module for version data processing, and wherein the databank is in communication via the second module for automatic postage table selection with an execution unit that is connected to a display unit for status messaging and with the communication unit.

17. An arrangement according to claim 15 comprising a system formed by the server and at least one service apparatus which are communicatively connected with one another after the call-in by the service apparatus has occurred.

18. An arrangement according to claim 15, wherein the server of the data center is a postage table specification server.

19. An arrangement according to claim 15 wherein the data center comprises a communication server and a databank server which are both operationally connected with the postage fee table specification server, the communication server comprising the communication unit and the databank server comprises the databank, and the postage fee table specification server comprising an input unit that is operationally connected with the first module for version data processing, and the postage fee table specification server comprising a second module for automatic postage table selection that enables an access to the databank and accesses the databank of the data center for automatic selection of postage fee tables, and wherein the second module for automatic postage table selection is operationally connected with an execution unit and a display unit.
